(19) United States
(12) Patent Application Publication
(10) Pub. No.: US 2005/0190169 A1
(43) Pub. Date: Sep. 1, 2005

(54) Method and device for testing a thin film transistor array

(75) Inventor: Kayoko Tajima, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc

(21) Appl. No.: 11/004,117

(22) Filed: Dec. 3, 2004

(30) Foreign Application Priority Data
Feb. 26, 2004 (JP) 2004-052046

(51) Int. Cl. G09G 5/00

(52) U.S. Cl. 345/204

(57) ABSTRACT

A TFT array having pixels comprised of a transistor for controlling current, a capacitor connected between the gate terminal and the source terminal of this transistor, a first switch connected between the gate terminal and the drain terminal of this transistor, a first control line for controlling this first switch, a second switch, one terminal of which is connected to the drain terminal of this transistor, and a second control line for controlling this second switch.

### FIELD OF THE INVENTION

The present invention relates to a TFT array that drives EL elements, a method for testing this TFT array, and a device for testing this TFT array, and in particular, to a method for testing a TFT array having current copy-type pixels, a method for testing this TFT array, and a device for testing this TFT array.

### DISCUSSION OF THE BACKGROUND ART

Attention has been focused in recent years on EL elements (electroluminescence elements) as display elements for flat panel displays. EL elements are self-emission-type elements; therefore, they are characterized in that their display color field is broad and their energy consumption is low when compared to display elements that use conventional liquid crystals.

The emission brightness of EL elements fluctuates with the drive current. Therefore, TFT arrays for driving EL elements differ from TFT arrays that are used in conventional voltage control-type liquid crystals in that a structure is necessary with which the current applied to the light-emitting element can be controlled (refer to JP Kokai [unexamined] 2004-4801 and JP Kokai [unexamined] 2003-323,152).

A current copy-type pixel structure is shown in FIG. 2. This is a pixel of a TFT array used to drive a typical EL element. Of electrodes 15 and 28 that connect an EL element 25 (the status of the TFT array is unsealed), electrode 15 is grounded, while the other electrode 28 is connected to transistor switch 23. The other terminal of transistor switch 23 is connected to the drain terminal of a drive transistor 22, which supplies the drive current of EL 25. A capacitor 24 is connected between the gate terminal and the source terminal of drive transistor 22. A drive power source 27 of EL element 25 disposed on the outside of pixel 2 is connected to the source terminal of drive transistor 22. In addition, a transistor switch 21 is connected between the gate terminal and the drain terminal of drive transistor 22, and a different transistor switch 20 is connected to the drain terminal. Transistor switches 20 and 21 are turned on and off by the same control line 12. The other terminal of transistor switch 20 is connected to a data line 10, and the data line is connected to a current source 26 disposed on the outside of pixel 2.

The operation of a pixel 2 in FIG. 2 will now be described. First, switches 20 and 21 are turned on by applying voltage to control line 12 and switch 23 is turned off by bringing control line 16 to “off” voltage. Thus, the current supplied from power source 27 flows through drive transistor 22 and switch 20 into current source 26. Current I that flows at this time is specified by current source 26. Moreover, because switch 21 is on, capacitor 24 is charged. The potential of capacitor 24 after charging is equal to the voltage V between the gate and the source when current I is flowing to drive transistor 22.

When capacitor 24 is completely charged, control line 12 is brought to the “off” voltage and switches 20 and 21 are turned off. Switch 21 is off; therefore, capacitor 24 maintains a potential difference V. Then voltage is applied to control line 16 and switch 23 is turned on. Thus, current flowing from power source 27 flows through drive transistor 22 and switch 23 to the EL element 25. The current flowing to the EL element 25 at this time is controlled by the voltage between the gate and the source of drive transistor 22. Capacitor 24 charged to the potential difference V is connected between the gate and the source of drive transistor 22; therefore, the voltage between the gate and the source becomes V. As previously mentioned, the current flowing through drive transistor 22 when the voltage between the gate and the source is V becomes I; as a result, the drive current of current I flows to the EL element 25.

Thus, drive transistor 22 in FIG. 2 is characterized in that the EL element 25 can be driven by current I specified by current source 26, even after the connection with current source 26 has been broken. Pixels having this type of characteristic are called current copy-type pixels. It should be noted that there is an embodiment wherein electrode 15 is not necessarily grounded and is connected to a pre-determined voltage source

TFT arrays are produced by successive formation of each functional part on a substrate by etching, vapor deposition, spin coating, and other unstable processes; therefore, TFT arrays with pixel defects are produced. Consequently, testing in order to determine whether a resulting TFT array has pixel defects is indispensable. Inspection of TFT arrays for defects involves evaluating whether or not current of the same amount as current source 26 grounded to data line 10 is supplied to the EL element 25. However, if defects appear once the EL element 25 has been sealed in the TFT array, the expensive EL element 25 will become useless. There is therefore a need for testing for pixel defects in TFT arrays before the EL material is sealed inside. On the other hand, drive current will not flow with the EL element 25 in an unsealed state because the drive circuit in FIG. 2 is not a closed circuit.

One method that is being considered is the method wherein a current similar to that during actual use is measured by allowing current that flows to drive transistor 22 to flow to data line 10 from which current source 26 has been removed and measuring this current. Specifically, once capacitor 24 has been charged to pre-determined voltage V, data line 10 is brought to the same potential as electrode 15 in a state of actual use (ground potential in the present example), current that flows between the drain and the source of drive transistor 22 is allowed to flow to data line 10, and the current I that flows to data line 10 is measured.

However, pixel 2 in FIG. 2 has a structure wherein the open and close operations of the first and second transistors are linked. As a result, if switch 20 is on when the current of data line 10 is being measured, switch 21 is also on. Therefore, it is possible to measure only the IV property when the gate electrode and the drain electrode are at the same potential. However, during actual use, switch 21 is turned off and the EL element 25 is driven and the gate electrode and the drain electrode are not at the same potential. There is therefore a problem with pixel 2 in FIG. 2 in that the current that flows through drive transistor 22 in a state of actual use cannot be measured.

### SUMMARY OF THE INVENTION

The present invention solves the above-mentioned problems with a thin film transistor array characterized in having pixels comprised of a transistor for controlling current, a capacitor connected between the gate terminal and the source terminal of this transistor, a first switch connected between the gate terminal and the drain terminal of this transistor, a first control line for controlling this first switch, a second switch, one terminal of which is connected to the drain terminal of this transistor, and a second control line for controlling this second switch.

That is, the current that flows to the drive transistor at the operating point during actual use is measured by separately controlling the first and second switches. More specifically, the present invention solves the above-mentioned problems by a testing method characterized in that it comprises a step wherein a power source is connected to the source terminal of this transistor, a step wherein the first and second switches are turned on, a step wherein a pre-determined current is applied to the other terminal of this second switch and this capacitor is charged, a step wherein the application of this current is stopped and this first switch is turned off, and a step wherein the current flowing through this second switch is measured.

The present invention makes it possible to check for defects in current copy-type pixels with the EL element in a state that is more similar to the state of actual use.

### BRIEF DESCRIPTION OF THE DRAWINGS

FIG. 1 is an explanatory drawing of the pixel and testing device related to the present invention.

FIG. 2 is a structural diagram of a conventional current copy-type pixel.

FIG. 3 is a schematic drawing of the TFT array and testing device related to the present invention.

### DETAILED DESCRIPTION OF THE PREFERRED EMBODIMENT

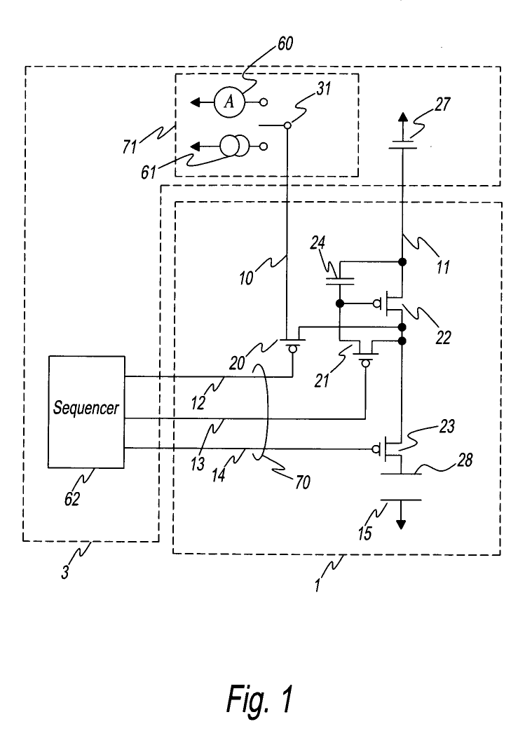

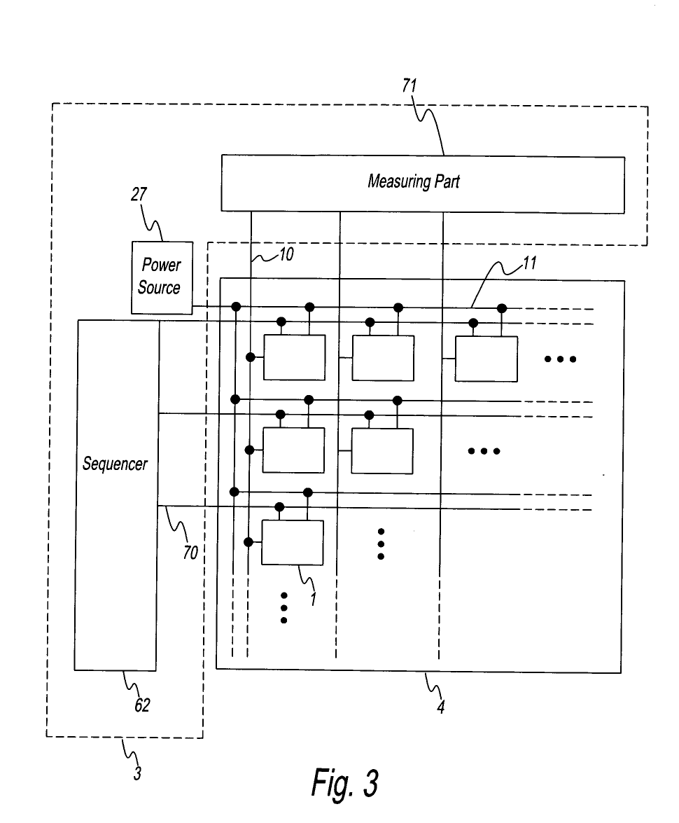

The testing method that is a preferred embodiment of the present invention will now be described in detail while referring to the drawings. FIG. 3 is a schematic drawing showing a TFT array 4 and a testing device 3 related to the present invention. FIG. 1 is an explanatory diagram that shows in further detail the electrical connection between a pixel 1, the test subject, and testing device 3.

TFT array 4 has plural pixels 1 lined up in matrix form. Each pixel has an electrical source line 11 for supplying the drive current to the EL element (the TFT array 4 is in an unsealed state) and data lines 70 and 10 connected to one another for selecting a pixel. Data line 70 is the digital signal line having the function of selecting the pixel that is the test subject and more specifically, consists of the three control lines 12, 13, and 14, as shown in FIG. 1. Moreover, data line 10 is an analog signal line that has the function of selecting the pixel that is the test subject and plays the role of indicating the drive current of the EL element (emission brightness). On the other hand, testing device 3 consists of a power source 27 for supplying power to power line 11, a sequencer 62 for controlling voltage that is applied to data line 70 (12, 13, 14) in accordance with the measurement sequence, and a measurement part 71 housing a current source 61, an ammeter 60, and other parts for measurement. It should be noted that switches 20, 21, and 23 are all P channel FETs and when −5 V is applied to the gate terminal, they turn on (“on” voltage), while when 0 V is applied, they turn off (“off” voltage).

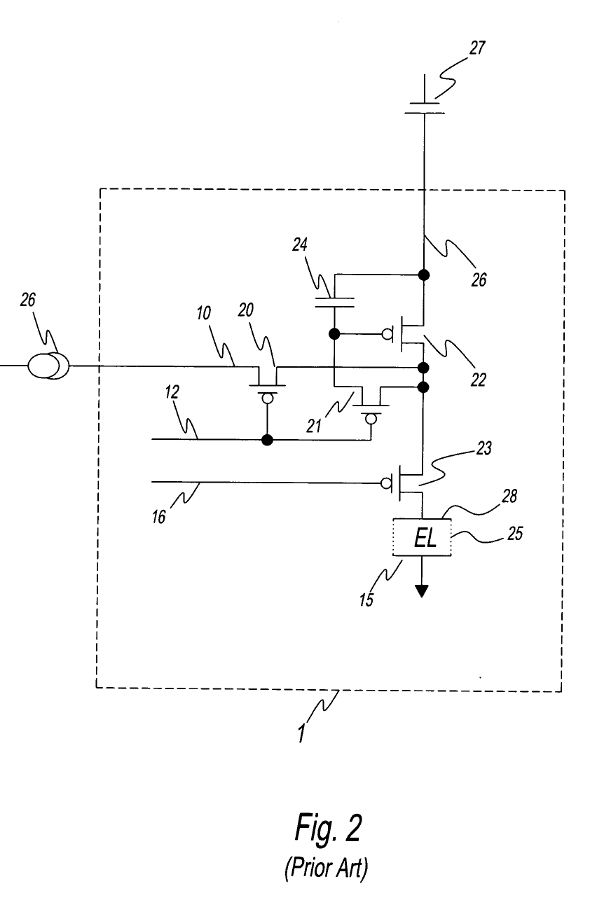

Pixel 1 and testing device 3 will now be explained in further detail while referring to FIG. 1. Pixel 1 of the present working example and pixel 2 in FIG. 2 described under the Prior Art Section differ primarily in that control line 12 of switch 20 and control line 13 of switch 21 are separate.

Of electrodes 15 and 28 that will be connected to the EL element (unsealed), electrode 15 is grounded and the other electrode 28 is connected to transistor switch 23. The other terminal of transistor switch 23 is connected to the drain terminal of drive transistor 22 that supplies drive current to the EL element. Capacitor 24 is connected between the gate terminal and the source terminal of drive transistor 22. Moreover, transistor switch 21 is connected between the gate terminal and the drain terminal of drive transistor 22 and a separate transistor switch 20 is connected to the drain terminal. Transistor switch 20 is turned on and off by control line 12, while transistor switch 21 is turned on and off by control line 13.

Next, the operation of pixel 1 and testing device 3 in FIG. 1 will be described. First, sequencer 62 applies “on” voltage to control lines 12 and 13 and switches 20 and 21 are turned on. Control line 14 is brought to “off” voltage and switch 23 is turned off. Moreover, a switch 31 is connected to current source 61. Thus, current that is supplied from power source 27 flows through drive transistor 22 and switch 20 into current source 61. Current I that flows at this time is determined by current source 61. Moreover, because switch 21 is on, capacitor 24 is charged. The potential V of capacitor 24 after charging is equal to the voltage V between the gate and the source when current I flows to drive transistor 22.

Once capacitor 24 is charged, sequencer 62 brings control line 13 to “off” voltage and switch 21 is turned off. Then switch 31 is connected to ammeter 60. Switch 21 is off; therefore, capacitor 24 maintains the potential difference V and current I flows to transistor 22. The current of transistor 22 flows through switch 20 to data line 10. Current I flowing to transistor 22 is measured by measuring this current with ammeter 60. It can be confirmed that pixel 1 is operating correctly if the measured current I is the same as the current of current source 61.

The test subject of the present working example is a TFT array before the EL element is sealed, but the present invention can also be used to test the operation of a TFT panel once the EL elements have been sealed inside. Moreover, as long as switches 20, 21, and 23 are switches that are turned on and off outside of pixel 1, they can be N-channel FET switches or a switch other than a transistor switch as well. Moreover, the other terminal of ammeter 60 is not necessarily connected directly as in the present embodiment and can be grounded via a resistor, a power source, and the like. Ammeter 60 for measuring the current flowing to transistor 22 is not necessarily disposed on the output side of switch 31 as in the present working example. Various modifications are possible, such as disposing the ammeter on the input side of switch 31 or at power line 11. There can also be plural ammeters 60. For instance, the leakage current inside pixel 1 can be simultaneously measured by measuring the amount of current at data line 10 and power line 11.

The technological concept of the present invention was described in detail while referring to specific examples, but it is clear to persons skilled in the art that various modifications and alterations are possible in the present invention without deviating from the essence or scope of the claims.

1. A thin film transistor array having pixels comprised of:
a transistor for controlling current, said transistor having a gate terminal, a source terminal and a drain terminal;
a capacitor connected between said gate terminal and said source terminal of said transistor;
a first switch connected between said gate terminal and said drain terminal of said transistor;
a first control line for controlling said first switch;
a second switch comprising another terminal which is connected to said drain terminal of said transistor; and
a second control line for controlling said second switch.

2. The thin film transistor array according to claim 1, wherein said pixels further comprise:
at least one electrode for connecting at least one electroluminescence element:
a third switch connected between said electrode and said drain terminal of said transistor; and
a third control line for controlling said third switch.

3. A method for testing a TFT array having pixels comprised of:
a transistor for controlling current, said transistor comprising a gate terminal, a source terminal and a drain terminal;
a capacitor connected between said gate terminal and said source terminal of said transistor;
a first switch connected between said gate terminal and said drain terminal of said transistor; and
a second switch comprising another terminal which is connected to said drain terminal of said transistor, wherein said method comprises:
connecting a power source to said source terminal of said transistor;
activating said first and second switches;
applying a predetermined current to said terminal of said second switch and charging said capacitor;
terminating the application of said current and deactivating said first switch and
measuring a current flowing through said second switch.

4. A testing device for testing a TFT array having pixels comprised of:
a transistor for controlling current, said transistor comprising a gate terminal, a source terminal and a drain terminal;
a capacitor connected between said gate terminal and said source terminal of said transistor;
a first switch connected between said gate terminal and said drain terminal of said transistor; and
a second switch comprising another terminal which is connected to said drain terminal of said transistor,
said testing device comprising:
a current source connected to an end of said second switch other than that of said terminal of said second switch;
a controller for controlling said first switch and said second switch; and
a current measuring part that measures a current flowing into said transistor.
